(19) United States
(12) Patent Application Publication
(10) Pub. No.: US 2012/0232733 A1
(43) Pub. Date: Sep. 13, 2012

(54) METHOD FOR DETERMINING, IN A PREDICTIVE MANNER, TYPES OF ROAD SITUATIONS FOR A VEHICLE

(75) Inventors: Anne Herbin, Maisons Alfort (FR); Benazouz Bradai, Bobigny (FR); Michel Basset, Heimsbrunn (FR); Jean-Philippe Lauffenberger, Rixheim (FR)

(73) Assignee: VALEO VISION, Bobigny Cedex (FR)

(21) Appl. No.: 13/378,742

(22) PCT Filed: Jun. 17, 2010
(86) PCT No.: PCT/EP10/58589

§ 371 Date: May 22, 2012

(30) Foreign Application Priority Data
Jun. 30, 2009 (FR) 0954450
Jun. 17, 2010 (EP) PCT/EP2010/058589

(51) Int. Cl. B60W 40/06; B60W 20/00

(52) U.S. Cl. 701/22; 701/36

(57) ABSTRACT

A method for determining, in a predictive manner, types of road situations of a vehicle comprising the following steps:
points defining at least one possible path situated in front of the vehicle are obtained from a navigation system,
for each point, at least one attribute describing the type of road environment associated with this point is extracted from the navigation system,
the attribute of this point is compared with that of the preceding point,
if the attributes are identical, a driving situation is deduced from this such that said driving situation is a function of the attribute of the preceding point,
if the two attributes are different, an end of driving situation is deduced from this, and a transition to a new driving situation is determined depending on the attribute of this point, in such a manner as to define a succession of driving situations for this path.

### CROSS-REFERENCE TO RELATED APPLICATIONS

This application claims priority to PCT Application PCT/EP2010/058589 filed Jun. 17, 2010, and also to French Application No. 0954450 filed Jun. 30, 2009, which applications are incorporated herein by reference and made a part hereof.

### BACKGROUND OF THE INVENTION

1. Field of the Invention

The present invention relates to a method for determining, in a predictive manner, driving situations for a vehicle. It also relates to a system for carrying out a predictive determination of driving situations and also to a vehicle equipped with the latter.

2. Description of the Related Art

It is notably applicable in the automobile industry, in particular to the control of computer-assisted driving systems.

With the development of electronics, sensor and telecommunications technologies, many solutions have been proposed to improve the driving safety or driving comfort of vehicles. These improvements are often qualified as computer-assisted driving systems. These computer-assisted driving systems generally act on the vehicle behavior according to the type of road situation of the latter.

In a known manner, some computer-assisted driving systems are for example aimed at controlling the orientation or the intensity of a beam lighting the road according to the type of road situation. The type of road situation reflects the state or the environment of the vehicle. It is for example determined on the basis of the speed, or the position of the vehicle in the lane or alternatively the proximity of the vehicle to obstacles, pedestrians or other vehicles.

Computer-assisted driving systems which are based on onboard sensors do not allow information to be processed far enough in front of the vehicle owing to the relatively short range of the sensors. For example, the range of an onboard camera does not reach beyond a few tens of meters in a straight line. Furthermore, the onboard sensors do not reach beyond a bend. Thus, they do not allow a situation to be foreseen sufficiently far in advance. In practice, these systems are therefore only appropriate for limited applications.

Other systems rely on combining the cartographic data coming from a navigation system with data coming from sensors. This combination allows a confrontation of the index of these two types of data. Furthermore, it allows information to be provided on areas that are difficult to access for the sensors and/or situated far in front of the vehicle, typically at a distance of around ten kilometers. Thus, a system has been invented that allows the lighting beam to be orientated as a function of the curvature of the road such as defined by sensors, white line sensors notably, and such as calculated as a function of coordinates of points on a map representing the road.

Furthermore, a single sensor is, in general, insufficient to gain sufficient knowledge of the situation. In order to confirm an item of information, it is generally necessary to use two or more sensors so as to utilize their redundancy and their complementarity.

In current navigation systems, the geometry of the road is represented by points linked to the center of the road and spaced out at irregular intervals. The input of the coordinates of these points is a source of inaccuracy. Moreover, the means for vehicle localization only rarely provide a precision of less than 10 or 15 meters. A precision of 10 to 15 meters is sufficient for guiding a point A to a point B. On the other hand, this precision of the position data coming from navigation systems is insufficient for driving-assistance applications, notably applications aiming to improve safety.

Aside from the position data, the points that constitute the maps of the navigation systems are also characterized by attributes. An attribute describes the type of road environment of the point with which it is associated and, in particular, the road network infrastructure and facilities at this point. It comprises for example one of the following pieces of information: number of traffic lanes, speed limit, intersection, rotary, bend, straight section, tunnel, etc.

Based on the position of the vehicle and by associating attributes describing the environment of the vehicle with the segments and with the points on the map, an electronic horizon is thus established. This electronic horizon represents an image of the paths that may be envisioned upstream of the vehicle. It is obtained from the navigation system via a hardware platform (including a processing unit, position sensors including a GPS or Galileo receiver for example, a gyroscope, etc,), or electronic platform and software modules. Based on the current position of the vehicle and by making use of the attributes associated with the points, the electronic horizon describes the environment of the vehicle.

These navigation systems can only provide current information with respect to the position of the vehicle. They do not allow a continuous and events-based view of a driving situation in front of the vehicle, whereas the continuous advance of the vehicle requires a control, which also needs to be continuous, of the computer-assisted driving systems. As a result, the advantages of navigation systems for controlling computer-assisted driving systems thus inevitably turn out to be limited.

### SUMMARY OF THE INVENTION

The goal of the present invention is to provide a solution to the aforementioned limitations. More particularly, it aims to provide, in a predictive manner, a continuous and events-based description of the environment in front of the vehicle.

For this purpose, the invention provides a method for determining, in a predictive manner, types of road situations of a vehicle, comprising the following steps:
points defining at least one possible path situated in front of the vehicle are obtained from a navigation system;
for each point, at least one attribute describing the type of road environment associated with this point in question is extracted from the navigation system;
the attribute of the point in question is compared with that of the preceding point;
if the attributes are identical, a driving situation is deduced from this such that said driving situation is a function of the attribute of the preceding point;
if the two attributes are different, an end of a driving situation corresponding to the preceding point is deduced from this and a transition to a new driving situation is determined as a function of the attribute of the point in question, so as to define a succession of driving situations for this path; and
a set of successive points is identified and a common road context is associated with the points of this set.

Thus, a succession of anticipated driving situations is obtained that the vehicle is about to engage, this succession of driving situations forming a new set referred to as “electronic event horizon” in the framework of the present application, that will henceforth be referred to as “horizon” for simplicity. This horizon can, for example, comprise the set of possible situations up to a certain distance from the vehicle, hence the reason for employing the term horizon. This distance depends on the electronic horizon supplied by the navigation system; for example, it can be in the range between 10 and 12 kilometers. As opposed to a conventional navigation system, which directly supplies current situations, the method according to the present invention provides situations that are events-based and continuous. As a result, they allow computer-assisted driving systems to be continuously controlled.

Indeed, on a journey, if several points exhibit different data, whereas the road context has not changed, the conventional methods of identification of the type of road situation based on current information will not reflect the reality. For example, in the case of a freeway crossing a town, the real road context will always be a freeway. However, some points of the navigation may then indicate a freeway, others may indicate a town. These indications may even alternate. The conventional method of identification of road context will then indicate town/freeway alternately, which does not correspond to the real situation. When, for example, this conventional method is applied to the control of a lighting beam, to go from a freeway beam to a town beam, the lighting devices will continually and frequently go from one beam to the other, whereas the road context remains identical. Some points of the navigation may even indicate both contexts simultaneously, for example freeway and town for the same point in the aforementioned example; in this example, there is then a risk of having a virtually stroboscopic lighting.

In contrast, the method according to the present invention will allow computer-assisted driving systems to be continuously controlled, thanks to the deduction of a common road context. It will therefore allow the aforementioned drawbacks to be avoided. For example, the vehicle will remain in freeway lighting beam mode, even when crossing a town.

Thus, preferably, the method according to the invention therefore identifies a set of successive points, where at least a part of the successive points exhibit different road context data and/or some points exhibit several different road context data for the same point, and a common road context is associated with the points of this set.

The method according to the invention could furthermore optionally provide at least one of any of the following features:
the attribute is one of the following data values: an intersection, a rotary, a bend, a straight section, an intersection on a rotary, an intersection on a bend, an intersection on a straight section, a tunnel, a bridge;
a computer-assisted driving system is controlled according to the driving situation determined in a predictive manner. By allowing the upcoming driving situations to be determined, the invention provides an events-based and continuous view of the horizon of the vehicle. This notion of events is not in the discrete sense, in other words not in the one-off sense but in the situation or driving state sense. A computer-assisted driving system can thus be controlled continuously and in a predictive manner or else the parameters of a computer-assisted driving system can be adapted with respect to the situation. The computer-assisted driving system carries out for example at least one of the following operations: actuation of a system for lighting the road integrated into the vehicle, detection of the presence of pedestrians, of vehicles or of road signs, adjustment of the speed of the vehicle. The computer-assisted driving system can also carry out an operation for switching from one mode of driving to another, for example switching from a thermal propulsion mode of the vehicle to an electric propulsion mode of the vehicle. The operations carried out by the computer-assisted driving system can be carried out by adapting the opening angle of the radar according to the driving situation;
for each point, an additional attribute relating to a road context data value is extracted from the navigation system and the determination of the driving situation is enhanced with the road context data value. The road context data value is one from amongst the following data values: “town”, “outside of town”, “freeway”, “other”. Thus, the invention not only takes into account attribute data but also the context of the environment situated in front of the vehicle. The predictive view based on the attributes is therefore enhanced by contextual information. As a result, the driving situations are described with a greater precision. For example, the invention supplies different information for a straight section in a town or on a freeway. This information is particularly useful when the need is, for example, to control a lighting beam;
a set of successive points is identified that exhibits an alternation of road context data and a common road context is associated with the points of this set. Thus, if the data coming from the navigation system exhibit an alternation incompatible with the reality, the method detects this incoherence and assigns a common context to this set of points. The continuity of the events-based view generated is therefore preserved. The computer-assisted driving system is consequently always continuously controlled. According to a preferred embodiment, all the road contexts are arranged as a hierarchy and the road context that is higher in the hierarchy amongst the road contexts of this set of points is chosen as common road context. For example, the set of successive points exhibits an alternation of the “town” and “freeway” contextual data, and the common road context associated with this set of points is the road context “freeway”. If a freeway runs through a town, it is highly probable that the navigation system will indicate a succession of points exhibiting an alternation of “town” and “freeway” contexts. The invention thus enables this incoherence to be lifted and the common context “freeway” to be assigned to all of these points. The driving situation will therefore definitely be associated with the context “freeway”. The computer-assisted driving system, if it is a system for controlling the light beams, will remain for example on freeway headlights and will not switch over to town headlights;
the steps for comparison of the attributes, for deduction of the transitions and for determination of the driving situations are carried out by a finite-state programmable controller;
the points for which the driving situations are determined correspond to the points of an itinerary defined by the navigation system according to a destination indicated by the user or, if no destination is indicated by the user, correspond to the points of the most probable itinerary. The most probable itinerary is defined on the basis of a past driving history and/or of cartographic data, for example the type of road on which the vehicle is driving. If this is on a freeway for example, there is a higher probability to remain on it than to exit;
a confidence index associated with the determination of the driving situation is calculated. The computer-assisted driving system is controlled only if the confidence index is greater than a threshold. The confidence index is a function of at least one from amongst the following parameters: localization of the vehicle by satellite localization means, precision of the digitization of the map, date of update of the map, environment of the vehicle, guidance mode selected or not;
data coming from at least one onboard sensor and data coming from or sent to the navigation system are merged. This merging step is applied such that the data coming from the sensor enhance the data coming from or sent to the navigation system so as to determine driving situations in a more precise manner; and
additionally or alternatively, the invention is arranged in such a manner that the data coming from the sensor supplements the data coming from or sent to the navigation system so as to determine driving situations even when the information coming from the localization means cannot be utilized.

In the framework of the invention, a system is also provided for determining driving situations for a vehicle in a predictive manner. This system comprises an onboard navigation device and processing means capable of implementing the method according to one of the preceding features. The system comprises a finite-state programmable controller for the implementation of at least a part of the preceding steps.

The invention furthermore relates to a vehicle comprising a system according to the preceding paragraph.

Other features, aims and advantages of the present invention will become apparent upon reading the detailed description that will follow, and with regard to the appended drawings, presented by way of non-limiting examples and in which:

### BRIEF DESCRIPTION OF THE ACCOMPANYING DRAWINGS

FIG. 1 shows schematically the various steps of one example of the method according to the invention;

FIG. 2 is a table of correspondence presenting examples of driving situations as a function of the attributes carried by cartographic points;

FIG. 3 illustrates one example of a map on which the invention can be based;

FIG. 4 draws up an exemplary list of contexts used for determining the driving situations;

FIG. 5 shows schematically the various steps of another example of the method according to the invention;

FIG. 6 describes an example of analysis implemented by a finite-state programmable controller in the framework of the invention;

FIG. 7 illustrates another exemplary application of the invention;

FIG. 8 illustrates an example of a map for yet another exemplary application of the invention;

FIG. 9 describes the analysis implemented by a finite-state programmable controller in the framework of the exemplary application in FIG. 8;

FIG. 10 is a table summarizing lighting strategies that may be applied in the framework of the implementation of the invention;

FIG. 11 illustrates an example of confidence index calculation according to the invention; and

FIG. 12 describes one example of a system according to the invention.

### DETAILED DESCRIPTION OF THE PREFERRED EMBODIMENTS

With reference to FIG. 1, the various steps are illustrated of one example of the method for determination of a type of road situation according to the invention.

Points defining at least one possible path situated in front of the vehicle are obtained from the navigation system (step 11).

The invention involves the use of a navigation system. In a known manner, a navigation system notably comprises means for localizing the vehicle and a base of cartographic data. Typically, the localization means incorporates a device for localization by satellite (GPS or Galileo in the future) with a receiver-transmitter installed onboard the vehicle.

Each path is represented by a set of points whose position is recorded in the cartographic data.

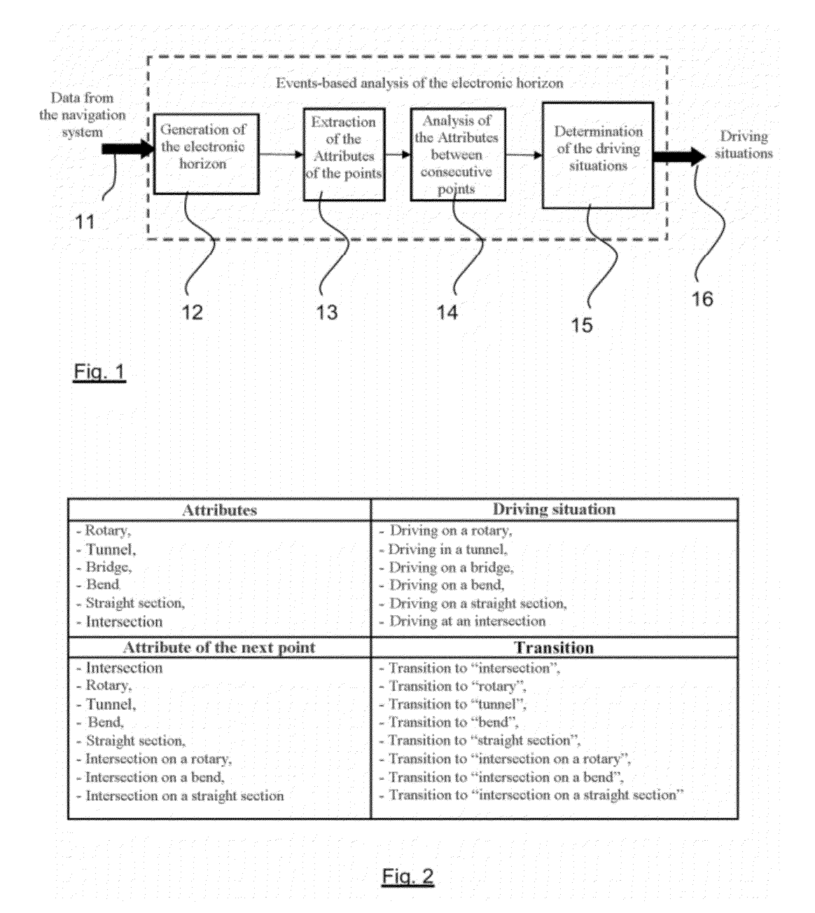

Furthermore, the cartographic data comprises attributes associated with the points. An attribute describes the type of road environment of the point with which it is associated and comprises for example one of the following items of information: number of traffic lanes, speed limits, intersection, rotary, bend, straight section, tunnel, bridge, etc. FIG. 2 draws up a list of some of the attributes used in the framework of the invention.

The combination of the localization means and the data from the map thus allow an electronic horizon to be defined in front of the vehicle (step 12). Advantageously, this electronic horizon is composed of the set of the possible paths upstream of the vehicle defined by the position of the points and of the type of road environment information associated with these points.

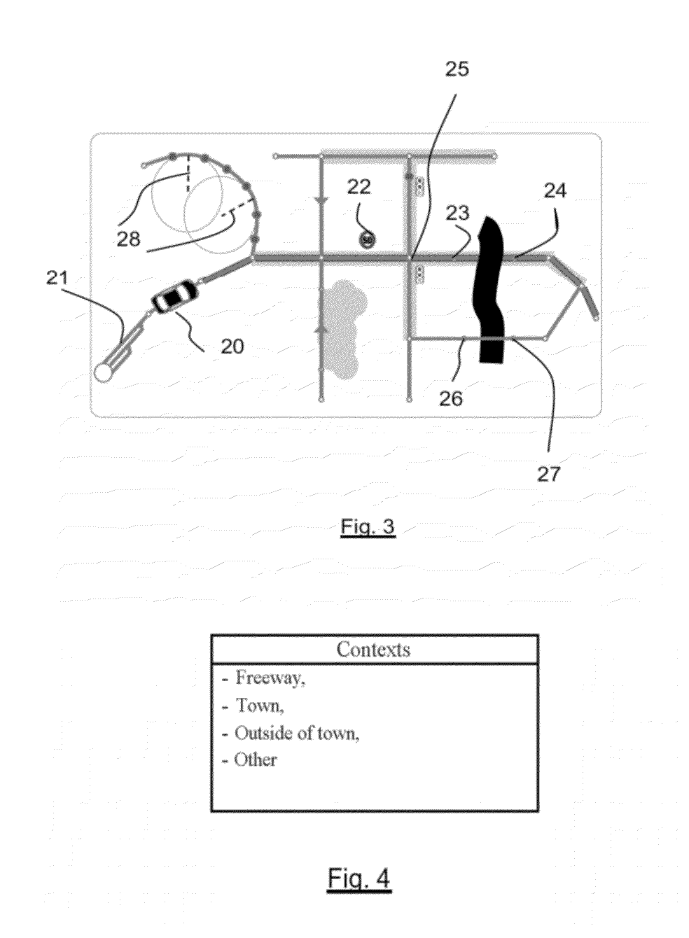

FIG. 3 illustrates one example of electronic horizon. This figure displays the location of the vehicle 20 and various points on the map. Some of these points, called nodes, symbolize intersections 25. The others points symbolizing the road are called points of form. These various points allow segments (seg01, seg02, etc.) to be bounded and the set of the paths that may be followed to be defined. These paths appear in FIG. 3. This figure also displays attributes associated with the various points such as for example: a number of lanes 21, a speed limit 22, a tunnel entrance 23, a tunnel exit 24, the start of a bridge 26, the end of a bridge 27, the radius of curvature of the road 28.

In a manner characteristic of the invention, the attributes associated with the points of the electronic horizon are to be extracted (step 13).

For a given point on the horizon, the attributes of this given point are analyzed and those that belong to a predetermined set are retained, such as the set indicated in FIG. 2. This attribute is compared with that of the preceding point (step 14).

The preceding point, with respect to a point in question, denotes a point adjacent to the point in question, situated on the same path as the point in question and disposed between the vehicle and the point in question. The next point, with respect to a given point, denotes a point consecutive to the given point in the direction of travel of the vehicle.

If the attributes of the point in question and of the preceding point are identical, a driving situation corresponding to the attribute of the preceding point is then deduced from this (step 15). A continuous driving situation between the two points is thus characterized. As long as consecutive attributes are identical, the same driving situation is then conserved. The invention thus offers an events-based and continuous description of the environment of the vehicle. On the basis of this driving situation, a continuous control can then be provided for example to a computer-assisted driving system (step 16). By determining the driving situations in the electronic horizon in advance, the corresponding control command can be saved and applied to the driving situations which are determined by the method of the present invention.

The correspondence between the attributes and the driving situations is for example carried out by means of a table of correspondence of the type presented in FIG. 2. One example of a table is provided in FIG. 2. For example, if two consecutive attributes are associated with the attribute “tunnel”, the method deduces from this the driving situation “driving in a tunnel” between these two points.

If the attributes of the point in question and of the preceding point are not identical, an end of driving situation based on the preceding point is then accordingly deduced. A driving transition and a start of a new driving situation is also deduced from this. The nature of this transition and the nature of the new driving situation are dictated by the point in question.

The determination of the driving transition according to the attribute of the point in question can also be based on a table of correspondence. For example, if the preceding point is associated with the attribute “straight section” and if the point in question is associated with the attribute “rotary”, then the method deduces from this an end of situation for “driving on a straight section” and determines a transition to a situation to come. According to this table of correspondence, this transition is of the type “transition to a rotary”.

These steps are iterated for a set of consecutive points. As long as the attributes are identical, the method accordingly deduces a continuous driving situation. A succession of driving situations is thus obtained whose starts and ends are bounded by the corresponding driving transitions.

The invention thus enables an electronic event horizon identifying all the driving situations in front of the vehicle to be generated by anticipation. This horizon is not limited to providing current information but predicts a succession of events, these events corresponding to driving situations. The electronic horizon generated by the invention can thus be qualified as an event horizon.

The event horizon is generated for one vehicle location. Typically, its range is of the order of 10 km. As the vehicle moves forward, this horizon is updated by taking into account cartographic data far enough in front of the vehicle to preserve the predictive nature of this horizon. The system according to the invention can thus be qualified as a progressive event horizon generator or progressive event horizon sensor.

The progressive event horizon generated by the invention consequently offers an analysis of the environment very close to the analysis performed by the driver.

Advantageously, the analysis of the environment and the generation of the control command are decoupled. This notably allows the complexity of the analysis program to be reduced and the program to be made more upgradable.

Reconsidering the example in FIG. 3, the progressive event horizon anticipates from amongst the possible driving situations after the intersection 25, the following driving situations: driving on a straight section (seg12), then driving in a tunnel (between the points 23 and 24), then transition to driving on a straight section, then driving on a straight section, etc.

In a preferred manner, the system according to the invention first of all determines the driving situations on the basis of attributes belonging to a predefined first set of attributes. Typically, this set encompasses the attributes listed in the non-exhaustive table in FIG. 2: intersection, rotary, tunnel, bridge, straight section, bend. These attributes correspond to a first level of information. They provide information on the direct road environment of the vehicle and characterize the road itself.

Advantageously, the system according to the invention extracts an additional attribute for each of the points. This additional attribute belongs to a predefined second set of attributes. This additional attribute provides a second level of information which is higher, in other words which is more general, than the first level. It characterizes, in particular, the road context of the vehicle. It is denoted as contextual data. Typically, this set encompasses the contextual data listed in the table in FIG. 4: town, freeway, outside of town, other. The term “other” represents the case where the navigation system has no information on the context. It thus allows the operational safety to be taken into consideration in order to switch to a degraded control mode, for example a control command as a function of the angle of the steering wheel. Generally speaking, when the system does not possess context or attribute information, it terminates the driving situation in progress and no longer generates any driving situation until new attributes and/or contexts are obtained.

The system according to the invention extracts this contextual data and analyses them in order to refine the description of the anticipated driving situations.

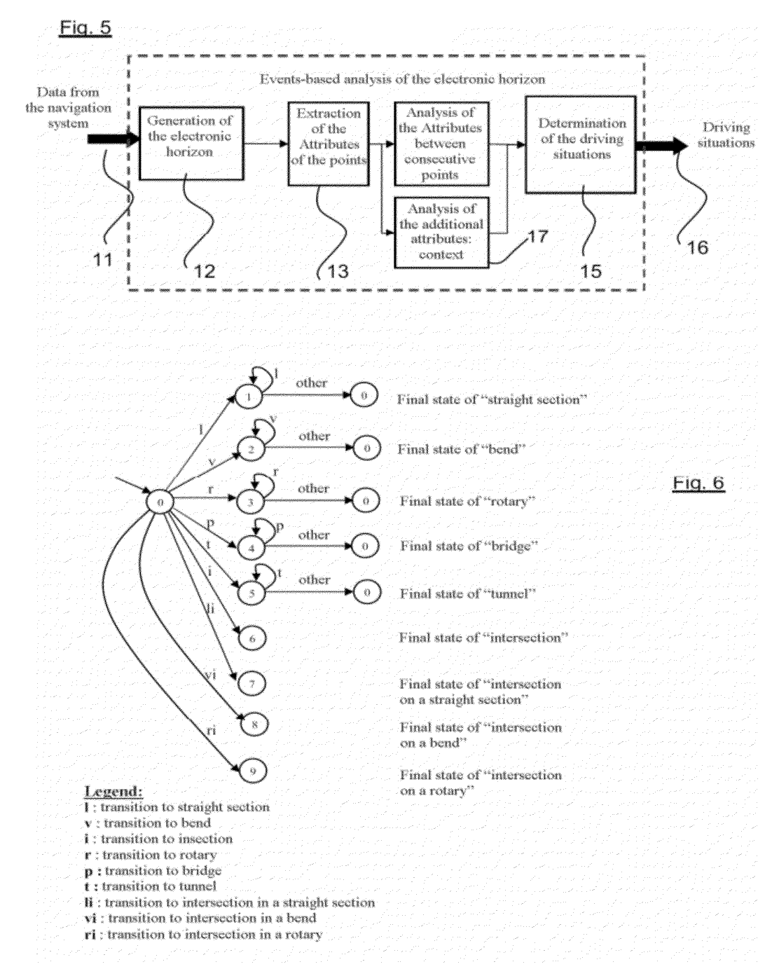

FIG. 5 illustrates the various steps of a method for determination of a type of road situation taking into account additional attributes. It includes the additional step 17 for analyzing the contexts and taking them into account in order to predict the driving situations.

Again taking the example in FIG. 3, if the vehicle is effectively travelling in “town” mode, the system extracts the aforementioned attributes together with the town context. It then determines the following driving situations after the intersection: “driving on a straight section in a town” (seg12), then a transition to “driving in a tunnel in a town”, marking the start of a “driving in a tunnel in a town” situation (between the points 23 and 24), then a transition to a “driving on a straight section in a town”, marking the start of a “driving on a straight section in a town” situation, etc.

Advantageously, the use of this context data allows the level of information on the predicted driving situations to be enhanced. A control rule based on the driving situations and used to control a computer-assisted driving system can then be defined with a greater precision.

Preferably, the various steps mentioned hereinabove involve the use of a finite-state programmable controller. The system furthermore comprises means for storing data needed for the identification of driving situations and the transitions according to the attributes. Advantageously, it comprises means for generating a control command acting on a computer-assisted driving system.

FIG. 6 describes one example of analysis structure constituting the finite-state programmable controller.

Starting from the initial state “0”, scanning the electronic horizon allows the transitions to be identified which correspond to the driving situations determined by the states of the programmable controller. Subsequently, as long as no new attribute is detected in the electronic horizon, the programmable controller remains in the corresponding state. Following the detection of a change of attribute (“other”), an end of the driving situation is indicated (“final state”). A new transition corresponding to the new driving situation is generated depending on this attribute. Except for the intersections, all of the situations considered are processed in this manner whatever the number of transitions carried out (one or more).

When an intersection is identified at a point in question, since the latter only appears in the map database as a single point representing both the start and the end of this situation, after detection of this situation, the programmable controller immediately reaches the final state at the point in question.

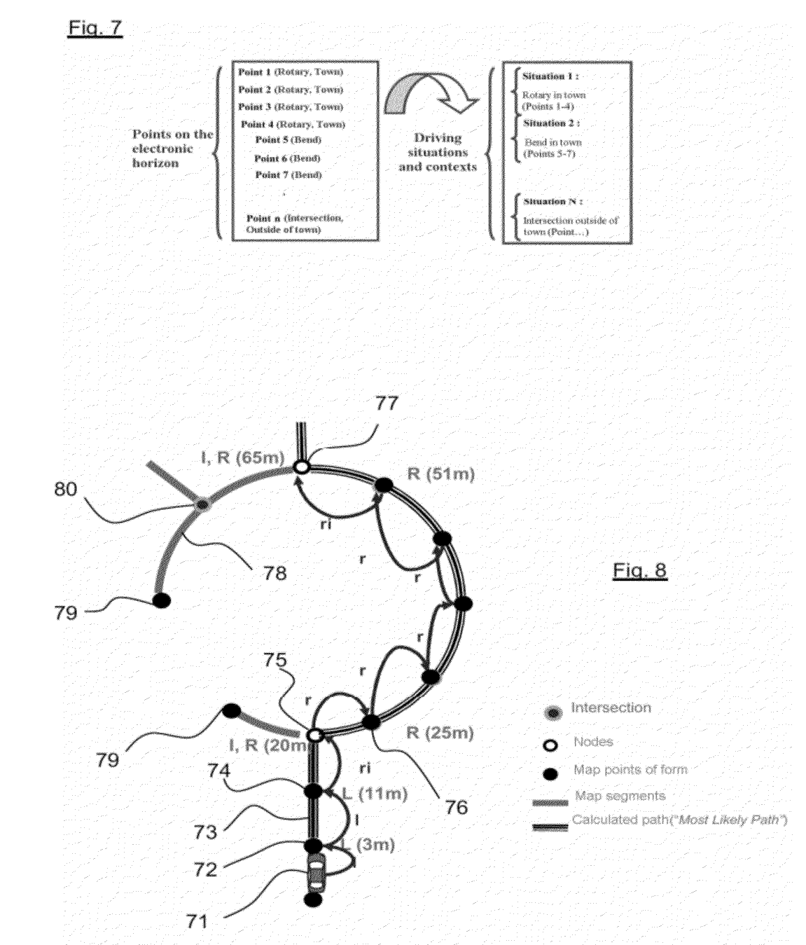

Finally, the progressive event horizon sensor defines the paths accessible to the vehicle in the form of a tree describing all the driving situations and the associated contexts, according to their imminence. One example of the generation of driving situations from the points of the electronic horizon supplied by the map is shown schematically in FIG. 7. A set of n points (point 1 to n) allows N driving situations (situations 1 to N with n>N) to be determined. These n points are associated with first level attributes (rotary, bend, intersection) and second level road contexts or attributes (town and outside of town). The driving situations are generated on the basis of the set of first level attributes and of the road contexts: “driving on a rotary in a town” for the points 1 to 4, “driving on a bend in a town” for the points 5 to 7, “intersection outside of town” for the point n.

The invention can be implemented whether the driver has indicated his destination to the navigation system or not.

In the case where this destination is indicated, the points for which the driving situations are determined correspond to the points of the itinerary defined by the navigation system as a function of this destination.

In the opposite case, the points for which the driving situations are determined correspond to the points of the most probable itinerary. Many well-known methods allow this most probable itinerary to be determined. Generally speaking, these methods take into account data from the navigation past history and/or map data, for example the type of road on which the vehicle is driving. If it is driving on a freeway for example, there is a higher probability of the car remaining on it than leaving it.

Preferably, and whether the guidance mode is active or not, all of the points of the electronic horizon will be analyzed so as to define a horizon comprising all the possible paths. Thus, all the driving situations are anticipated.

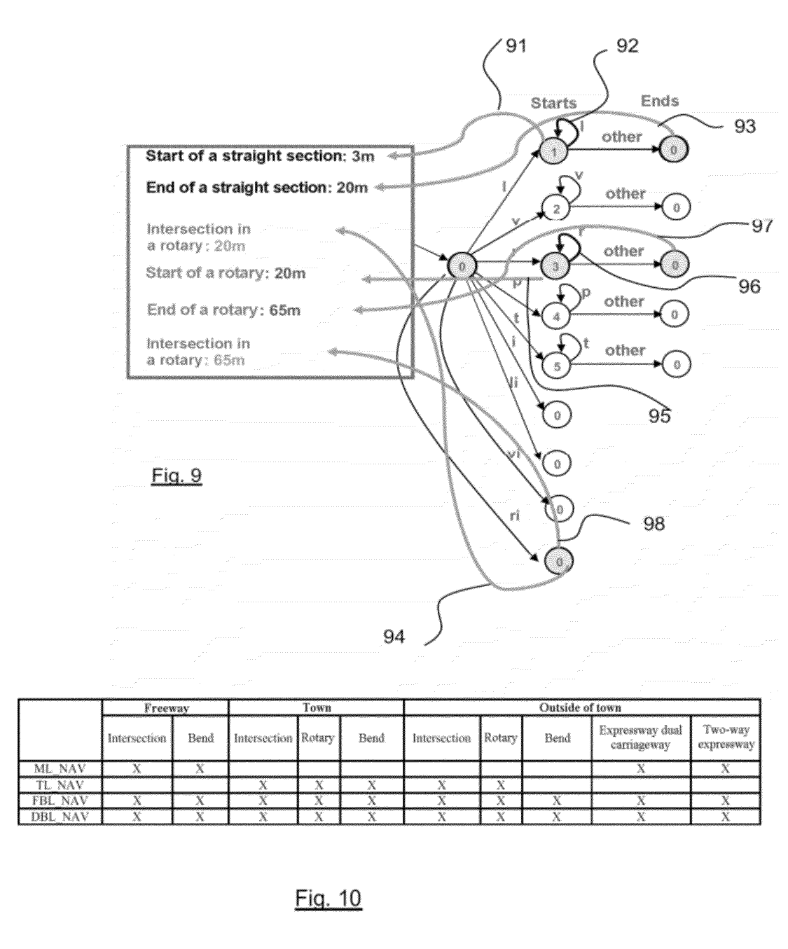

One exemplary application of the invention will now be detailed with reference to FIGS. 8 and 9.

The system determines the path that the vehicle has the highest probability of following. This path is represented by two thin lines on either side of a thicker line. The system according to the invention extracts the various points of form (72-74, 76, 79.) and the nodes (75, 77, 80), these nodes representing the intersections on the map. It analyses the attributes of these points. By analysis of the attribute of the first point 72 situated in front of the vehicle 71, it identifies the start of a straight section at 3 meters (attribute “L”) (step 91). Since the analysis of point 74 also carries the straight section attribute (attribute “L”), this allows the driving situation “driving on a straight section” on the segment 73, bounded by the points 72 and 74, to be determined. The programmable controller does not therefore change state over this portion (step 92). The node 75 is associated with an attribute for intersection on a rotary (attribute “I, R”). This node 75 triggers a change of state of the programmable controller and the end of the driving situation (step 93) “driving on a straight section”. The system deduces from this that this driving situation terminates at 20 meters.

This same node 75 marks a situation for transition to an intersection on a rotary (step 94). It also marks the start of a new driving situation corresponding to “driving on a rotary” which starts at 20 meters (step 95). The next five points are associated with the rotary attribute (“R”). The programmable controller does not therefore change state (step 96) until the node 77 which carries the attribute for intersection on a rotary (attribute “I, R”). The programmable controller again changes state, detects the end of the driving situation “driving on a rotary” at 65 meters (step 97) and determines a transition to an intersection on a rotary (step 98).

The invention thus allows driving situations particularly close to the reality to be generated even in as complex environments as the rotaries. The event horizon described is also perfectly continuous. Thanks to the invention, perfectly coherent and continuous control rules may then be deduced from these driving situations.

Taking the hypothesis that the context associated with each of these points is the context “town” and based on the table in FIG. 10 described in greater detail hereinbelow and which summarizes control strategies for a lighting beam, the segments of the straight section would therefore have a normal lighting and the rotary a beam broadened by a function denoted TL_NAV. This function, as made clear hereinbelow, corresponds to a beam broadening.

A control rule based on the current information supplied by the navigation system would lead to a single-point control rather than a continuous one. Such a rule would, for example, lead to an incoherent succession of on and off actions, in particular at night on a rotary outside of a town.

Preferably, the invention is arranged so as to identify whether a set of successive points exhibits an incoherent alternation of road context data. This alternation may apply to two or more different road contexts, and it may not necessarily be 1 for 1. The invention is designed to identify whether the alternation frequency is incompatible with the reality.

For example, it is frequently the case that when a freeway passes through a town, some points, or even all the points, on the map each simultaneously possess a context “town” and a context “freeway”. This can generate an alternating control command between “town” and “freeway” if the contextual data as such is used for the control, in other words without events-based analysis of the horizon as provided by the invention. Applied for example to a lighting beam control, such a control command generates a rapid on/off alternation of power to the headlamps, an action which is unacceptable in terms of driving safety and comfort.

The invention is also designed to associate a common road context with this set of points. The continuity of the progressive event horizon generated is therefore preserved. The control based on this horizon is consequently also continuously controlled.

In order to determine the common road context that should be chosen for all of these points, all the road contexts are arranged in a hierarchy and the road context highest up in the hierarchy is chosen as common road context.

Taking the previous case of the freeway running through a town, a higher hierarchical level is assigned to the context “freeway” than to the context “town”. Thus, the common road context which is chosen in this case is the road context “freeway”. The driving situation generated will therefore take into account the context “freeway” for this set of points. This driving situation anticipated by the invention therefore truly corresponds to the reality in spite of the incoherence introduced by the navigation data. The control rule based on the driving situations will therefore be perfectly adapted. If this control rule relates to the lighting, the freeway lighting mode will therefore remain on over the whole portion of freeway.

With reference to FIG. 10, control strategies for a lighting beam from the vehicle will now be presented. More particularly, the progressive event horizon sensor, subject of the invention, receives the command to be applied from an adaptive front lighting system generally denoted by the acronym AFS.

In a known manner, an AFS system provides the following conventional functions:
Pseudo—TL (Town Lighting) function

The purpose of this function is to broaden the light beam (left and right) for urban driving. This device is only activated depending on the speed of the vehicle. Typically, it is activated if the speed falls below a threshold, for example 50 Km/h. The control rule for the AFS function therefore depends only on a speed sensor.
Pseudo—ML (Freeway Lighting) function

This function consists in raising the headlamps into freeway mode. It is only activated depending on the speed of the vehicle, typically if the speed exceeds a threshold, for example of 80 Km/h. The control rule for the AFS function therefore depends only on a speed sensor.
FBL (Fixed Bending Light)

This function provides a progressive lighting of the left-hand or right-hand inside verge depending on the rotation of the steering wheel. The control rule for the AFS function therefore depends only on an angular position sensor.
DBL (Dynamic Bending Light)

This function provides a progressive rotation of the lighting optics as a function of the rotation of the steering wheel. The control rule for the AFS function therefore depends only on an angular position sensor.
None of these functions is controlled by a control rule taking into account the environment of the vehicle.
As an alternative, some AFS systems are designed for the control of these functions to be carried out not as a function of a steering wheel angle data value (FBL, DBL) but as a function of the position of points supplied by the navigation system map. These points allow a road profile to be defined and the curvature of the road to be calculated. The control rule is based on the curvature of the road for triggering a progressive lighting of the inside verge (left-hand, right-hand) or a progressive rotation of the lighting optics.
The invention provides new control rules. These new control rules allow the control of the functions of the adaptive front lighting system (AFS) to be improved. To this end, the idea is to base the control rules on the driving situations such as determined in the manner indicated hereinabove.
The table in FIG. 10 presents control strategies that are particularly advantageous for various lighting functions of the AFS type as a function of the driving situations defined, on the one hand, by the first level attributes (intersection, rotary, straight section, bend, expressway dual-carriageway or otherwise) and, on the other hand, by the road contexts (freeway, town, outside of town). This table presents the following functions:
TL_NAV

This function consists in broadening the light beam, left or right, for urban driving. This function is controlled by a control rule which is based on the driving situations such as detected by the method subject of the present invention. According to the strategies defined in the table in FIG. 10, if a driving situation carrying the context “driving in a town” is determined, then the beam broadening function can be triggered. If the context detected is “driving outside of town” and if the driving situation determined on the basis of the first level attribute is “driving on a bend” or “driving on an expressway dual carriageway” or “driving on a two-way expressway”, then the control rule will prevent the broadening of the beam. Prior to arriving at a rotary, the driving situation “driving on a rotary outside of town” will be determined. Once the vehicle has arrived at the rotary, the control rule will once again authorize the broadening of the beam.
ML_NAV

This function consists in applying the lighting adapted to the freeway when a driving situation “driving on a freeway” or “driving outside of town on an expressway dual carriageway” or “driving outside of town on a two-way expressway” is detected.
FBL_NAV

This function provides a progressive lighting of the inside verge (left-hand, right-hand) on a bend depending on the driving situations and on the contexts determined according to the method of the invention and identified in the table in FIG. 10.
DBL_NAV

This function provides a progressive rotation of the lighting optics on a bend depending on the driving situations and on the contexts determined according to the method of the invention and identified in the table in FIG. 10.

The invention proves to be particularly advantageous when it is applied to the functions FBL_NAV and DBL_NAV. Indeed, with the conventional FBL or DBL functions, the progressive lighting or the progressive rotation of the optics is triggered by the rotation of the steering wheel. The lighting function is therefore triggered when the vehicle has already engaged the bend. The existing solutions do not therefore allow the lighting on entry into the bend to be improved. Conversely, the progressive event horizon sensor according to the invention allows the entry into a bend to be anticipated well in advance. The progressive lighting or the progressive rotation of the optics is therefore triggered sufficiently in advance of the bend to improve the visibility as soon as the vehicle enters the bend.

The same is true at the exit from the bend. The invention anticipates the exit from the bend by means of the progressive event horizon sensor and generates a control command as a result, well before the angle of the steering wheel allows the exit from the bend to be predicted.

Furthermore, the control rule for each of these functions, in addition to being based on the driving situations, can also be based on data coming from sensors (speed or angle of the steering wheel for example) or on the position data of the points on the map. This combination of data will be described in detail with reference to FIG. 12.

Thus, these functions couple the conventional AFS functions and the AFS functions assisted by the navigation. Consequently, the invention improves the control rules and allows the AFS lighting functions to be optimized.

In order to further improve these AFS lighting functions, the control rule takes into account the following specific features:
the FBL function is always coupled with the DBL function on a freeway, outside of town, on regional roads, national highways and on expressways. The vehicle therefore has low-beam headlights selected and the FBL and DBL functions are activated; and
the TL function takes priority over the FBL function. Thus, depending on the case, the lighting will be low-beam+TL+DBL and not low-beam+FBL+DBL. This is the case in a town or outside of a town for intersections and rotaries.

The activation of some of the functions must comply with the regulations in force.

At least one of the following situations must be verified for the function TL to be activated:
the vehicle is in a built-up area and the speed of the vehicle is less than 80 Km/h;
the vehicle is on roads equipped with public lighting and the speed of the vehicle is less than 80 Km/h; and
the speed of the vehicle is less than 50 Km/h.

For the ML function to be activated, the speed of the vehicle must be higher than 70 Km/h and the following situations must be verified:
the vehicle is on a freeway AND/OR the speed of the vehicle is higher than 110 Km/h; and
a wait time of 2 minutes is required prior to activation when the freeway has be detected.

Preferably, the invention defines a confidence index relating to the driving situation determined by anticipation. This confidence index affects the extent to which the control rule is applied to the computer-assisted driving system. Typically, if this index is less than a predefined threshold, the control rule based on the driving situation is not applied to the computer-assisted driving system and a control command based on other non-anticipating sensors is applied in this case. For example, in the case of an AFS lighting, the vehicle switches to AFS control based on the angle of the steering wheel or on the speed.

Preferably, the confidence index is calculated based on one or more of the criteria from the following non-exhaustive list:
the level of information on the road: this criterion reflects, in particular, the precision of the map;
the functional class of the road: this criterion takes into account the precision of the attributes associated with a class of road;
the type of road environment: town, freeway exit, intersection, etc.;
the precision of positioning of the vehicle by the satellite localization means (GPS or Galileo in the future);
guidance mode selected (indication by the user of an itinerary) or not; and
the date of the update of the map.

Advantageously, the confidence index is calculated by taking into account each of these criteria. For the calculation of the confidence index, each of these criteria may be weighted. These weights are determined as a function of the reliability of the criteria to which they are assigned. They may be defined by experience or by learning.

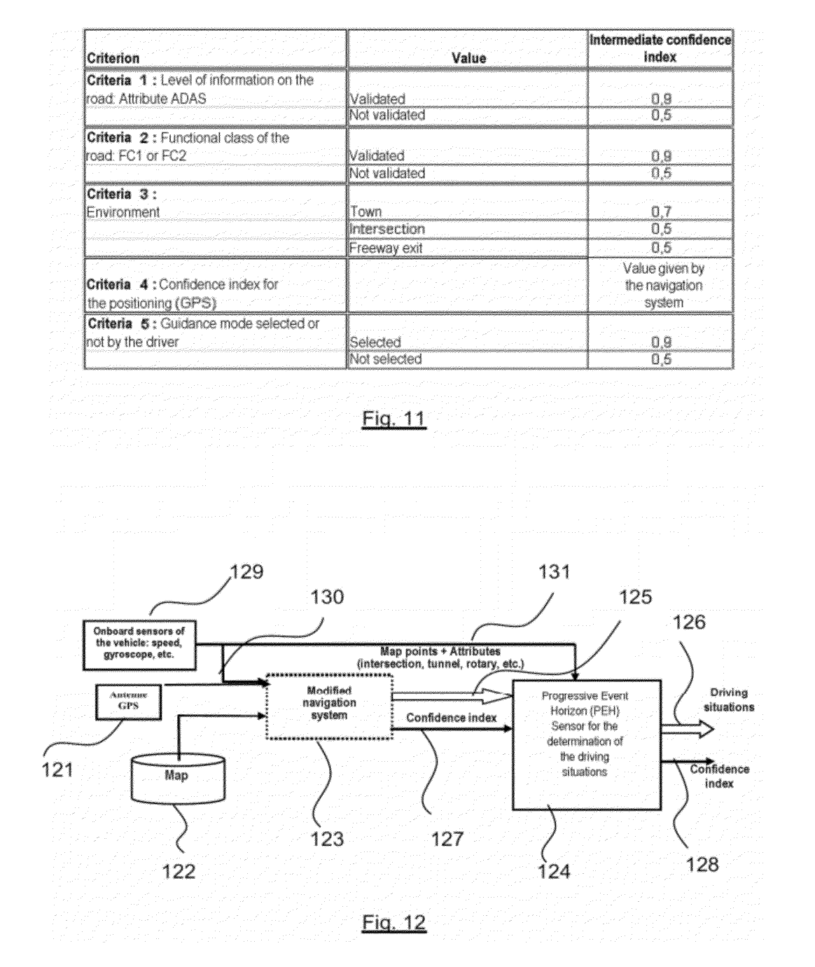

FIG. 11 presents one example of a calculation of the confidence index of the system for determination of the driving situations.

In one particular embodiment, the invention is configured for using data coming from onboard sensors. FIG. 12 shows schematically one example of such a system.

The invention comprises a navigation system 123, receiving data coming from the satellite localization means 121. These means have been described previously. The invention also comprises a database 122 supplying the navigation system with cartographic data.

The data 125 coming from the navigation system is transmitted to the progressive event horizon sensor 124. The latter includes a finite-state programmable controller. It determines the driving situations 126. These driving situations are for example designed to be sent to a computer-assisted driving system. The navigation system 123 also supplies a confidence index 127, corresponding to the precision of the positioning specific to the satellite positioning system, to the progressive event horizon sensor 124. The latter calculates a confidence index, for example according to the method illustrated in FIG. 11, integrating into it other criteria, and transmits the finalized confidence index 128 with the driving situations 126.

The invention also comprises at least one onboard sensor 129 such as a speed or a gyroscopic sensor providing information on the angle of the steering wheel or on the angle of the wheels.

The data 130 from the onboard sensor 129 can be transmitted to the navigation system 123. This data 130 can supplement or be merged with that coming from the localization means or from the map, in particular when the navigation system operates in a degraded mode. For example, if the signal from the localization means disappears, the angle data for the steering wheel and/or speed data can enable the system to continue to localize the vehicle on the map, at least temporarily.

Furthermore, the data 131 from the onboard sensor 129 may be transmitted to the progressive event horizon sensor 124. This data 131 is then combined with that coming from the navigation system in order to improve the determination of the driving situations. For example, the data from a speed sensor allows the data coming from the localization means, relating to the speed or the position of the vehicle, to be refined. For the adaptive front lighting functions of the Dynamic Bending Light type consisting in driving the optics in rotation, it is indeed important that the speed data taken into account by the control rule is as close as possible to the actual speed of the vehicle as it enters a curve or in a curve. However, it is not easy to obtain precise information on speed based only on the localization means.

The merging of data coming from onboard sensors and of data coming from or sent to the navigation system therefore allows driving situations to be determined in a more precise manner and in a degraded mode of operation.

Indeed, the computer-assisted driving system operates in a degraded mode when the confidence index of the progressive event horizon sensor is below the predefined threshold and thus switches into degraded mode control using the onboard sensors (for example the DBL based on the angle of the steering wheel or the ML based on the speed).

Advantageously, the invention uses the data from a plurality of onboard sensors of different types.

This merging of the data coming from the navigation system and from the onboard sensors is for example implemented for the AFS lighting strategies described with reference to FIG. 10.

The present invention is not limited to the embodiments described hereinabove, but covers any embodiment conforming to its spirit.

Notably, although it is advantageous, for each of the points, to analyze first of all the attributes (first level attributes) then the context, the inverse analysis could be carried out. Only analyzing the context of the points on the electronic horizon may also be envisioned.

While the system and apparatus herein described constitute preferred embodiments of this invention, it is to be understood that the invention is not limited to this precise system and apparatus, and that changes may be made therein without departing from the scope of the invention which is defined in the appended claims.

What is claimed is:

1. A method for determining, in a predictive manner, types of road situations of a vehicle, comprising the step for obtaining, from a navigation system, points defining at least one possible path situated in front of the vehicle, said method comprising the steps of:
for each point, at least one attribute describing the type of road environment associated with this point in question is extracted from the navigation system;
the attribute of the point in question is compared with that of the preceding point;
if the attributes are identical, a driving situation is deduced from this such that said driving situation is a function of the attribute of the preceding point;
if the two attributes are different, an end of a driving situation is deduced from this and a transition to a new driving situation is determined as a function of the attribute of the point in question, so as to define a succession of driving situations for this path; and
a set of successive points is identified and a common road context is associated with the points of this set.

2. The method as claimed in claim 1, in which at least a part of said set of successive points exhibit different road context data and/or some points exhibit several different road context data for the same point.

3. The method as claimed in claim 1, in which the attribute is one of the following: an intersection, a rotary, a bend, a straight section, an intersection on a rotary, an intersection on a bend, an intersection on a straight section, a tunnel, a bridge.

4. The method as claimed in claim 1, in which a computer-assisted driving system is controlled according to the driving situation determined in a predictive manner.

5. The method as claimed in claim 4, in which the computer-assisted driving system carries out at least one of the following operations:
actuation of a system for lighting the road integrated into the vehicle;
detection of the presence of pedestrians, of vehicles or of road signs;
adjustment of the speed of the vehicle; and
passage from a thermal propulsion mode of the vehicle to an electric propulsion mode of the vehicle.

6. The method as claimed in claim 5, in which the operations are carried out by adapting an opening angle of a radar according to the driving situation.

7. The method as claimed in claim 1 in which, for each point, an additional attribute relating to a road context data value is extracted from the navigation system and the determination of the driving situation is enhanced with the road context data value.

8. The method as claimed in claim 7, in which the road context data value is one from amongst the following data values: “town”, “outside of town”, “freeway”, “other”.

9. The method as claimed in claim 8, in which all the road contexts are arranged as a hierarchy and the road context that is hierarchically superior amongst the road contexts of this set of points is chosen as common road context.

10. The method as claimed in claim 1, in which the set of successive points exhibits an alternation of the “town” and “freeway” context data, and the common road context associated with this set of points is the road context “freeway”.

11. The method as claimed claim 1, in which the points for which the driving situations are determined correspond to the points of an itinerary defined by the navigation system according to a destination indicated by the user or correspond to the points of an itinerary defined as the most probable.

12. The method as claimed in claim 1 in which a confidence index associated with the determination of the driving situation is calculated.

13. The method as claimed in claim 12, in which the computer-assisted driving system is controlled only if the confidence index is greater than a threshold.

14. The method as claimed in claim 12, in which the confidence index is a function of at least one from amongst the following parameters: satellite positioning system, precision of the digitization of the map, date of the update of the map, environment of the vehicle, guidance mode selected or otherwise.

15. A system for determining, in a predictive manner, driving situations for a vehicle, wherein it comprises an onboard navigation device and processing means configured for implementing the method as claimed in claim 1.

16. A system for determining, in a predictive manner, types of road situations of a vehicle, said system comprising:
a navigation system adapted to use points defining at least one possible path situated in front of the vehicle, said navigation system comprising:
for each point, at least one attribute describing the type of road environment associated with this point in question is extracted from the navigation system;
said at least one attribute of the point in question is compared with that of the preceding point; and
if said attributes are identical, a driving situation is deduced from this such that said driving situation is a function of the attribute of the preceding point;
if the two attributes are different, an end of a driving situation is deduced from this and a transition to a new driving situation is determined as a function of the attribute of the point in question, so as to define a succession of driving situations for this path; and
said navigation system further identifying a set of successive points and a common road context is associated with the points of this set.

17. The system as claimed in claim 16, in which at least a part of said set of successive points exhibit different road context data and/or some points exhibit several different road context data for the same point.

18. The system as claimed in claim 16, in which said at least one attribute is one of the following: an intersection, a rotary, a bend, a straight section, an intersection on a rotary, an intersection on a bend, an intersection on a straight section, a tunnel, a bridge.

19. The system as claimed in claim 16, in which said system comprises a computer-assisted driving system that is controlled according to the driving situation determined in said predictive manner.

20. The system as claimed in claim 16, in which the computer-assisted driving system carries out at least one of the following operations:
actuation of a system for lighting the road integrated into the vehicle;
detection of the presence of pedestrians, of vehicles or of road signs;
adjustment of the speed of the vehicle; and
passage from a thermal propulsion mode of the vehicle to an electric propulsion mode of the vehicle.
